(19) United States
(12) Patent Application Publication
(10) Pub. No.: US 2016/0264108 A1
(43) Pub. Date: Sep. 15, 2016

(54) COLLISION AVOIDANCE APPARATUS

(71) Applicant: TOYOTA JIDOSHA KABUSHIKI KAISHA, Toyota-shi (JP)

(72) Inventor: Tomoaki HARADA, Toyota-shi (JP)

(73) Assignee: TOYOTA JIDOSHA KABUSHIKI KAISHA, Toyota-shi (JP)

(21) Appl. No.: 15/047,379

(22) Filed: Feb. 18, 2016

(30) Foreign Application Priority Data
Mar. 13, 2015 (JP) 2015-051350

(51) Int. Cl. B60T 7/22

(52) U.S. Cl. CPC B60T 7/22

(57) ABSTRACT

A collision avoidance apparatus for a vehicle includes an object sensor that detects one or more objects around the vehicle; and an electronic control unit that (i) determines a likelihood for the vehicle to collide with the object, based on at least one of a distance between the vehicle and the object, and a relative speed of the object with respect to the vehicle; and (ii) starts executing a drive support to avoid the collision between the vehicle and the object when the likelihood of the collision is greater than or equal to a first level. A value of the first level is reduced in a case where a number of objects detected by the object sensor is less than or equal to a predetermined number than in a case where the number of the objects is greater than the predetermined number.

### CROSS REFERENCE TO RELATED APPLICATION

The present application is based on and claims the benefit of priority of Japanese Priority Application No. 2015-051350, filed on Mar. 13, 2015, the entire contents of which are hereby incorporated by reference.

### FIELD

The disclosure herein generally relates to a collision avoidance apparatus to avoid a collision between a vehicle and an object around the vehicle.

### BACKGROUND

Conventionally, a drive support technology has been known that determines a likelihood of a collision between a vehicle and an object (a preceding vehicle or the like) around the vehicle, and avoids the collision between the vehicle and the object, by issuing an alarm, or having the brake operate automatically (see, for example, Japanese Laid-open Patent Publications No. 2013-14225 and No. 2012-121534).

It is often the case that such a drive support technology usually determines timings to start respective drive supports (alarming, automatic braking, etc.), based on a relative position and a relative speed of the object with respect to the vehicle, which are detected by an object detection unit such as a radar or a camera. Also, from the viewpoint of securely avoiding a collision between the vehicle and the object, it is desirable to set the timings as early as possible relative to a predicted timing of the collision between the vehicle and the object.

However, if the drive supports are started at comparatively early timings that are determined uniformly, the following inconvenience may arise.

Specifically, if the number of objects detected by the object detection unit is comparatively greater, detection precision may be worse for the relative position and relative speed of an object with respect to the vehicle, and/or detection of an object itself may be executed less precisely. For example, if using a radar as the object detection unit when there are comparatively many objects to be detected, there is a likelihood that reflected waves from the objects may overlap each other. Therefore, it is necessary to separate a reflected wave that corresponds to one of the objects among the overlapping reflected waves. This may make the precision inferior for detection of the object, and detection of the relative position and relative speed of the object with respect to the vehicle. Also, if using a camera as the object detection unit when there are comparatively many objects to be detected, there is a likelihood that objects may overlap each other in a captured image. Therefore, precision may be inferior for identifying a range that corresponds to one of the objects in the captured image, and consequently, the precision may be inferior for detection of the relative position and relative speed of the object with respect to the vehicle. Therefore, when there are comparatively many objects to be detected, if a configuration is adopted to start the drive supports at comparatively early timings uniformly, there is a likelihood that unnecessary drive supports are executed highly frequently, due to less precise information (e.g., the relative position and relative speed of the object), erroneous detection of an object, and the like.

### SUMMARY

According to an embodiment, a collision avoidance apparatus for a vehicle includes an object sensor configured to detect one or more objects around the vehicle, including an object with which a collision is to be avoided; and an electronic control unit configured to (i) determine a likelihood of collision of the vehicle with the object, based on at least one of a distance between the vehicle and the object, and a relative speed of the object with respect to the vehicle; and (ii) start executing a drive support to avoid the collision between the vehicle and the object when the likelihood of the collision is greater than or equal to a first level. A value of the first level is reduced in a case where a number of objects detected by the object sensor is less than or equal to a predetermined number than in a case where the number of the objects is greater than the predetermined number.

### BRIEF DESCRIPTION OF DRAWINGS

FIG. 1 is a block diagram that illustrates an example of a configuration of a vehicle that includes a collision avoidance apparatus;

FIG. 2 is a main flowchart that schematically illustrates an example of a drive support start process by a collision avoidance apparatus (or a PCS-ECU);

FIG. 3 is a sub-flowchart of the drive support start process illustrated in FIG. 2;

FIGS. 4A-4C are sub-flowcharts of the drive support start process illustrated in FIG. 2; and

FIGS. 5A-5B are flowcharts that schematically illustrate examples of drive support release processes by a collision avoidance apparatus (or a PCS-ECU).

### DESCRIPTION OF EMBODIMENTS

In the following, embodiments will be described with reference to the drawings.

### First Embodiment

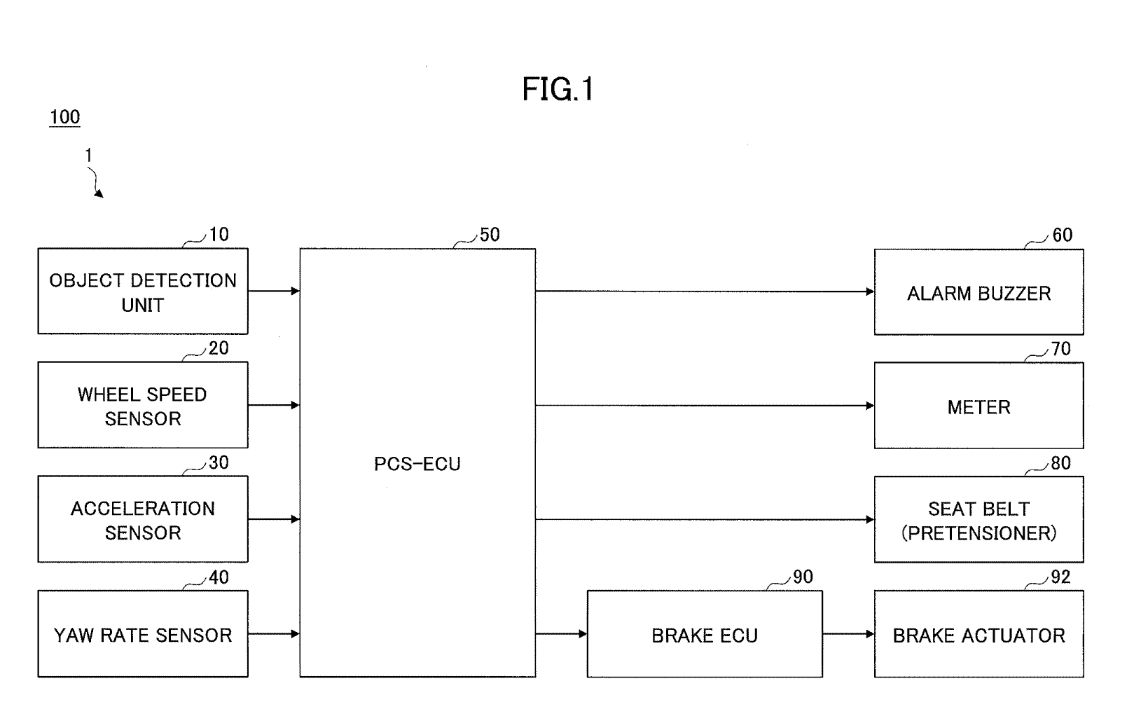

FIG. 1 is a block diagram that illustrates an example of a configuration of a vehicle 100 that includes a collision avoidance apparatus 1. In the following, notations about directions, “front”, “rear”, “left”, “right”, “up”, and “down” designate the front, rear, left, and right, up, and down directions, respectively, with respect to the vehicle 100.

The collision avoidance apparatus 1 executes drive supports to avoid a collision with an object, for example, a preceding vehicle, a pedestrian, a fixed object on a road, etc., positioned ahead of the vehicle 100. The drive supports will be described in detail later.

Note that the vehicle 100 may be any vehicle such as a vehicle having an engine as the only driving force source, or an electrically driven vehicle (e.g., a hybrid vehicle, a range extender vehicle, or an electric vehicle having a motor as the only driving force source).

The collision avoidance apparatus 1 according to the present embodiment is configured to include an object detection unit 10 (object sensor), a wheel speed sensor 20, an acceleration sensor 30, a yaw rate sensor 40, a pre-crash-safety electronic control unit (PCS-ECU) 50, an alarm buzzer 60, a meter 70, a seat belt(s) 80, a brake ECU 90, and a brake actuator 92.

The object detection unit 10 detects an object, for example, a preceding vehicle, a pedestrian, a fixed object on a road, etc., ahead of the vehicle 100, and is configured to be capable of detecting multiple objects that exist ahead of the vehicle 100. Also, the object detection unit 10 is configured to be capable of detecting the relative position of a detected object with respect to the vehicle 100 (referred to as the “relative position of the detected object” below), the relative speed of the detected object (referred to as the “relative speed of the detected object” below), the size of the detected object (e.g., the width in the left and right direction), and the like.

Note that the relative position of an object includes, for example, the distance from the vehicle 100 to the object (referred to as the “distance to the detected object” below), and the direction of the object as viewed from the vehicle 100 (referred to as the “direction of the detected object” below).

The object detection unit 10 may be a known radar sensor (e.g., a millimeter-wave radar, etc.), a light detection and ranging (LIDAR) sensor, or a supersonic wave sensor to detect an object ahead of the vehicle 100, for example, by transmitting a detection wave (e.g., a radio wave, laser, a supersonic wave, etc.) forward from the vehicle 100, and receiving a reflected wave that corresponds to the detection wave. In the following, a radar sensor, a LIDAR sensor, a supersonic wave sensor and the like are collectively referred to as the “radar sensor and the like” that detect an object ahead of the vehicle 100, based on a transmitted detection wave. Also, the object detection unit 10 may be a known camera sensor to detect an object ahead of the vehicle 100, by capturing an image ahead of the vehicle 100 by using an imaging element, for example, a charge coupled device (CCD) or a complementary metal-oxide semiconductor (CMOS), and applying predetermined image processing to the captured image. Also, the object detection unit 10 may be configured to include both a radar sensor and a camera sensor.

Note that the radar sensor may be configured to be installed in the vehicle 100, for example, around the center in the left and right direction of the front bumper or in the front grill, and to transmit a detection wave in a predetermined range of angles in the left and right direction, and in the up and down direction around a predetermined axis (optical axis) that extends ahead of the vehicle 100, set at the center. Also, the camera sensor may be configured to be installed in the vehicle 100, for example, around the center in the left and right direction of an upper part of the front window in the vehicle compartment, and to capture an image in a predetermined range of angles in the left and right direction, and in the up and down direction around an imaging direction that extends ahead of the vehicle 100, set at the center. Also, if the object detection unit 10 is configured to include both the radar sensor and the camera sensor, the object detection unit 10 may take advantage of both characteristics or features to generate information that integrates the relative position of an object, the relative speed of the object, the object direction, and the like detected by both sensors.

The object detection unit 10 transmits information about the detected object including the relative position of the detected object (the distance to the detected object, the object direction of the detected object, etc.), the relative speed, and the size (e.g., width) of the detected object (i.e., detected object information), to the PCS-ECU 50. Also, the object detection unit 10 transmits the detected object information and the number of objects being detected (referred to as “the number of detected objects N” below) to the PCS-ECU 50.

Note that the object detection unit 10 is connected with the PCS-ECU 50 to enable communication between the devices via a communication line for one-to-one connection (e.g., a direct line), an in-vehicle LAN, or the like. Also, if there are multiple detected objects, the object detection unit 10 may transmit object information about all detected objects, or may transmit object information about a detected object having the shortest distance to the vehicle 100 (in other words, the detected object posing a highest emergency as a target of the drive supports to avoid a collision).

Also, a part of functions in the object detection unit 10 may be executed by a unit outside of the object detection unit 10 (e.g., the PCS-ECU 50). For example, the object detection unit 10 may only execute detecting an object, by transmitting a detection wave and receiving a reflected wave by the radar sensor, and/or by capturing an image ahead of the vehicle 100 by the camera sensor, and other processing functions such as detecting and/or calculating the relative position of the detected object and the like may be executed by the PCS-ECU 50.

The wheel speed sensor 20 is an example of a vehicle speed detection unit configured to detect the speed of the vehicle 100. The wheel speed sensor 20 is provided for each wheel of the vehicle 100, and configured to be capable of detecting the rotational speed of the wheel (i.e., wheel speed), and outputting a signal that corresponds to the wheel speed of the wheel (i.e., wheel speed signal). The wheel speed sensor 20 is connected with the PCS-ECU 50 to enable communication between the devices via a direct line, an in-vehicle LAN or the like, to output and transmit a wheel speed signal to the PCS-ECU 50.

Note that based on the wheel speed signals, the PCS-ECU 50 can obtain the speed of the vehicle 100. For example, the PCS-ECU 50 can obtain the speed of the vehicle 100 by calculating the speed of the vehicle 100 from the wheel speed signal of a driven wheel, which is a wheel other than driving wheels that drive the vehicle 100, of the vehicle 100.

The acceleration sensor 30 is a known acceleration detection unit configured to detect acceleration acting on the vehicle 100, and is specifically positioned at or near the center of gravity of the vehicle 100, with an orientation enabling detection of acceleration Gx of the vehicle 100 in the forward and backward direction, acceleration Gy in the left and right direction, acceleration Gz in the up and down direction. The acceleration sensor 30 is connected with the PCS-ECU 50 via a direct line, an in-vehicle LAN, or the like to enable communication between the devices, to transmit signals that correspond to the acceleration Gx, Gy, and Gz (i.e., acceleration signals) to the PCS-ECU 50.

The yaw rate sensor 40 is a known angular velocity detection unit configured to detect a yaw rate of the vehicle 100, or rotational angular velocity around an axis passing through the center of gravity of the vehicle 100 in the up and down direction, and is positioned at or near the center of gravity of the vehicle 100 as the acceleration sensor 30 is. The yaw rate sensor 40 is connected with the PCS-ECU 50 via a direct line, an in-vehicle LAN, or the like to enable communication between the devices, to transmit a signal that corresponds to the yaw rate (i.e., yaw rate signal) to the PCS-ECU 50.

Note that the acceleration sensor 30 and the yaw rate sensor 40 may be configured to be an integrated acceleration/yaw rate sensor contained in the same housing.

The PCS-ECU 50 is an electronic control unit configured to execute a main control process in the collision avoidance apparatus 1. The PCS-ECU 50 may be configured with, for example, a microcomputer to execute various control processes by running various programs stored in a memory (e.g., ROM), on a CPU.

Note that the PCS-ECU 50 is connected with the alarm buzzer 60, the meter 70, the seat belts 80 (including pretensioners, which will be described later), the brake ECU 90, and the like to enable communication between the devices via an in-vehicle LAN or the like.

The PCS-ECU 50 calculates a time to collision (TTC, or an expected time to collision) that corresponds to a time (i.e., predicted time) expected to elapse before the vehicle 100 would collide with an object when the object is detected ahead of the vehicle 100 by the object detection unit 10. The calculation may include setting the TTC to a predetermined value. For example, based on detected object information (e.g., a distance D to the object and a relative speed V of the detected object) received from the object detection unit 10, the PCS-ECU 50 calculates a TTC (e.g., =D/V). Also, the PCS-ECU 50 may calculate the TTC, considering a moving state of the vehicle 100, based on signals including wheel speed signals, acceleration signals and a yaw rate signal received respectively from the wheel speed sensors 20, the acceleration sensor 30, and the yaw rate sensor 40. Specifically, if the speed of the vehicle 100 based on the wheel speed signal is very low, the PCS-ECU 50 may determine that the likelihood is low for a collision between the vehicle 100 and the detected object, and thus set the TTC, for example, to a comparatively great value. Also, by using acceleration and deceleration of the vehicle 100 in the forward and backward direction based on the acceleration signals, the PCS-ECU 50 may calculate the TTC, considering change of the relative relationship with the detected object caused by the acceleration and deceleration of the vehicle 100 after having started calculating the TTC. Also, by using a turning radius of the vehicle 100 based on the yaw rate signal, the PCS-ECU 50 may determine whether it is possible to avoid a collision between the vehicle 100 and the detected object by a steering operation by the driver, and then, to calculate the TTC. Also, the PCS-ECU 50 may calculate the TTC, considering a history of detected object information (e.g., a time series of past relative positions of the object).

Specifically, the PCS-ECU 50 may determine whether the vehicle 100 collides with the detected object, by estimating a trajectory of the detected object before the vehicle 100 collides with the detected object from the past trajectory of the detected object calculated from the time series of past relative positions of the detected object, and then, to calculate the TTC.

Note that if determining that it is possible to avoid a collision between the vehicle 100 and the detected object, by a steering operation by the driver, or by the estimated trajectory of the detected object, the PCS-ECU 50 may set the TTC, for example, to a comparatively large value.

Also, based on the calculated TTC, the PCS-ECU 50 executes drive supports (e.g., alarming, occupant restraining, and automatic braking) in order, to avoid a collision between the vehicle 100 and the object detected by the object detection unit 10. In the following, the drive supports executed by the PCS-ECU 50 will be described.

Note that among the drive supports that will be described in the following, the alarming and automatic braking are drive supports to avoid a collision between the vehicle 100 and the detected object, and the occupant restraining is a drive support that is executed associated with the automatic braking.

First, at a predetermined timing based on the TTC, namely, if the TTC is less than or equal to a threshold Ton_th1, the PCS-ECU 50 starts alarming to warn the driver of the vehicle 100. Specifically, the PCS-ECU 50 outputs an operation signal to the alarm buzzer 60, and outputs an alarm display signal to the meter 70. Thus, the alarm buzzer 60 makes a buzzer sound, and the meter 70 displays an alarm that indicates a likelihood of a collision with an object ahead of the vehicle 100. Therefore, the driver of the vehicle 100 can recognize that there is a likelihood of a collision with the object.

Note that if there is another ECU that directly controls the alarm buzzer 60, the PCS-ECU 50 may output an operational request of the alarm buzzer 60 to the other ECU. Also, if there is another ECU that directly controls the meter 70 (e.g., a meter ECU), the PCS-ECU 50 may output a request for displaying an alarm to the meter ECU.

Next, at a predetermined timing after the alarming based on the TTC, namely, if the TTC is less than or equal to a threshold Ton th2 (<Tonthl), the PCS-ECU 50 starts restraining the occupant(s) of the vehicle 100 by the seat belt(s) 80.

Specifically, the PCS-ECU 50 outputs an occupant restraining signal to the seat belt 80 (or a pretensioner, which will be described later). This makes the pretensioner rewind a slack part of the webbing of the seat belt 80, and hence, can minimize movement of the occupant of the vehicle 100 if the vehicle 100 suddenly decelerates by the automatic braking, which will be described later.

Note that if there is another ECU that directly controls the seat belt 80 (or the pretensioner), for example, an occupant protection ECU that controls an airbag(s) and the like, the PCS-ECU 50 may output a request of occupant restraining by the seat belt 80 to the occupant protect ECU. Also, since the occupant restraining is a drive support that is executed associated with the automatic braking, the threshold Ton_th2, and a threshold Ton_th3 that corresponds to a timing to start the automatic braking as will be described later, are set to values very close to each other. Also, the threshold Ton_th2 is set appropriately considering a relationship with the threshold Ton_th3 to complete restraining the occupant of the vehicle 100 at a timing to start the automatic braking, which will be described later.

Next, at a predetermined timing just after the occupant restraining based on the TTC, namely, when the TTC is less than or equal to the threshold Ton_th3 (<Ton_th2), the PCS-ECU 50 generates a braking force of the vehicle 100 automatically (i.e., automatic braking). Specifically, the PCS-ECU 50 outputs a request for automatic braking to the brake ECU 90, and the brake ECU 90 controls the brake actuator 92 to generate a braking force of the vehicle 100 automatically. The braking force operating on the vehicle 100 by starting the automatic braking, increases, for example, stepwise (e.g., in two stages) after starting the automatic braking, and reaches a maximum value for avoiding a collision with the detected object.

The drive supports including the alarming, occupant restraining, and automatic braking by the PCS-ECU 50 are continued until the vehicle 100 is stopped by the automatic braking. However, if a preceding vehicle as the detected object accelerates or changes lanes, or the vehicle 100 decelerates or changes lanes to avoid a collision between the vehicle 100 and the detected object, execution of the drive supports may be released.

To be specific, if the TTC is not less than or equal to a threshold TFoff_th1 (≧TFon_th1) after having started the alarming, the PCS-ECU 50 releases the execution of the alarming. Specifically, the PCS-ECU 50 outputs an operation release signal to the alarm buzzer 60, and outputs an alarm display release signal to the meter 70.

Also, if the TTC is not less than or equal to a threshold Toff_th3 (≧Ton_th3) after having started the alarming, the PCS-ECU 50 releases the automatic braking and the occupant restraining. Specifically, the PCS-ECU 50 outputs an automatic braking release request to the brake ECU 90, and outputs an occupant restraining release signal to the seat belt 80 (or the pretensioner).

Also, if the object is no longer detected by the object detection unit 10, the PCS-ECU 50 releases the execution of the drive supports including the alarming, occupant restraining, and automatic braking.

The alarm buzzer 60 is an alarm unit configured to alert the driver of the vehicle 100 that there is a likelihood of a collision. The alarm buzzer 60 operates in response to an operation signal received from the PCS-ECU 50, to sound a buzzer. Also, if receiving an operation release signal from the PCS-ECU 50 during the operation (e.g., buzzing), the alarm buzzer 60 stops the operation (i.e., stops sounding the buzzer).

The meter 70 is an indication unit (e.g., a display unit) to display various vehicle states, for example, vehicle speed, engine rotational speed, shift range, etc., and various information items so as to convey information to the driver of the vehicle 100. In response to an alarm display signal from the PCS-ECU 50, the meter 70 displays an alarm indicating that there is a likelihood of a collision with an object ahead of the vehicle 100, for example, an indicator such as a character, a symbol, a figure, etc. Also, if receiving an alarm display release signal from the PCS-ECU 50 while displaying the alarm, the meter 70 stops displaying the alarm.

The seat belt 80 is a known occupant restraining unit configured to restrain an occupant of the vehicle 100 by rewinding a slack part of the webbing, and has the pretensioner that can hold a state of no looseness for a certain time. For example, the pretensioner includes a motor, and has a configuration in which the webbing can be rewound by an operation of the motor. In response to receiving an occupant restraining signal from the PCS-ECU 50, the seat belt 80 (or the pretensioner) rewinds a slack part of the webbing, and generates a predetermined tension or a pulling force to operate on the webbing, for restraining the occupant of the vehicle 100. Also, in response to receiving an occupant restraining release signal from the PCS-ECU 50 while restraining the occupant, the seat belt 80 (or the pretensioner) releases a state in which the predetermined tension has been generated by the motor, to release restraining the occupant of the vehicle 100.

Note that the pretensioner may restrain the occupant of the vehicle 100 by pulling the webbing and the buckle by a pyro mechanism (i.e., explosion power of powder). In this case, the occupant restraining is not released by the PCS-ECU 50. To be specific, occupant restraining is gradually released while the effect of the explosion power of the powder dampens.

The brake ECU 90 is an electronic control unit that executes braking control in the vehicle 100 (i.e., controls operational states of the brake apparatus in the vehicle 100). The brake ECU 90 controls, for example, the brake actuator 92 that actuates hydraulic brake apparatuses placed at wheels of the vehicle 100. The brake ECU 90 may be configured with, for example, a microcomputer to execute various control processes, by running various programs stored in a memory (e.g., ROM), on a CPU.

Note that the brake ECU 50 is connected with the brake actuator 92 to enable communication between the devices via a direct line or the like.

The brake ECU 90 may execute a control process to determine output (e.g., wheel cylinder pressure) of the brake actuator 92, usually in response to a braking operation by the driver. For example, the brake ECU 90 may set pressure of the master cylinder (i.e., master cylinder pressure) that corresponds to a braking operation, to be the output of the brake actuator 92 (e.g., wheel cylinder pressure).

Also, in response to a request for automatic braking received from the PCS-ECU 50, the brake ECU 90 may execute a control process to generate a braking force of the vehicle 100 automatically, irrespective of a braking operation by the driver (i.e., automatic braking control). For example, the brake ECU 90 may control the brake actuator 92 to generate predetermined oil pressure irrespective of the master cylinder pressure, and to output the predetermined oil pressure, or pressure equalling the predetermined oil pressure added to the wheel cylinder pressure. Specifically, by controlling various valves, pumps, and the like included in the brake actuator 92, which will be described later, the brake ECU 90 causes the brake actuator 92 to generate the predetermined oil pressure, to output the predetermined oil pressure, or pressure equalling the predetermined oil pressure added to the wheel cylinder pressure. Also, if the vehicle 100 is an electrically driven vehicle, the brake ECU 90 may generate a braking force of the vehicle 100 automatically, by having the motor output (regenerative operation) controlled depending on a request for automatic braking from the PCS-ECU 50.

Note that the PCS-ECU 50 and the brake ECU 90 may be arbitrarily implemented by hardware, software, or firmware, or a combination of these as long as the functions described above can be implemented. Also, a part of or all of the functions of the PCS-ECU 50 and the brake ECU 90 may be implemented by the other ECUs. For example, a part of or all of the functions of the brake ECU 90 may be implemented by the PCS-ECU 50, and a part of or all of the functions of the PCS-ECU 50 may be implemented by the brake ECU 90.

The brake actuator 92 is a unit configured to generate output that makes the brake apparatus (e.g., the hydraulic brake apparatus described above) operate in the vehicle 100. The brake actuator 92 may include, for example, a pump (including a motor to drive the pump) to generate high oil pressure, various valves, and a hydraulic circuit, and may have any configuration as long as the output can be raised (e.g., boosting the wheel cylinder pressure) irrespective of an amount of a brake operation by the driver. Typically, the brake actuator 92 may include a high oil pressure source other than the master cylinder (e.g., a pump or an accumulator to generate comparatively high oil pressure), or may adopt a configuration that is used for a brake-by-wire system represented by an electronically controlled braking (ECB) system.

Next, a process to start drive supports by the collision avoidance apparatus 1 according to the present embodiment (referred to as a “drive support start process” below) will be described in detail.

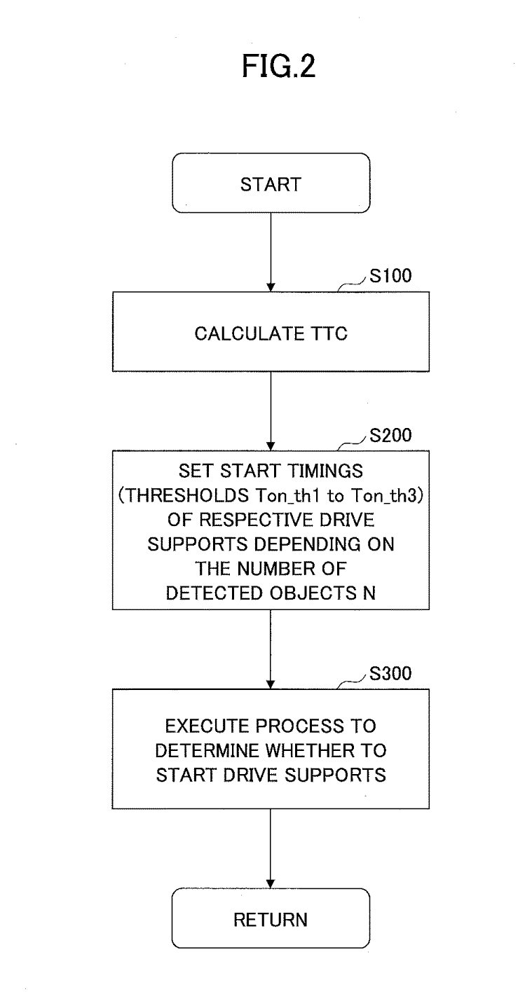

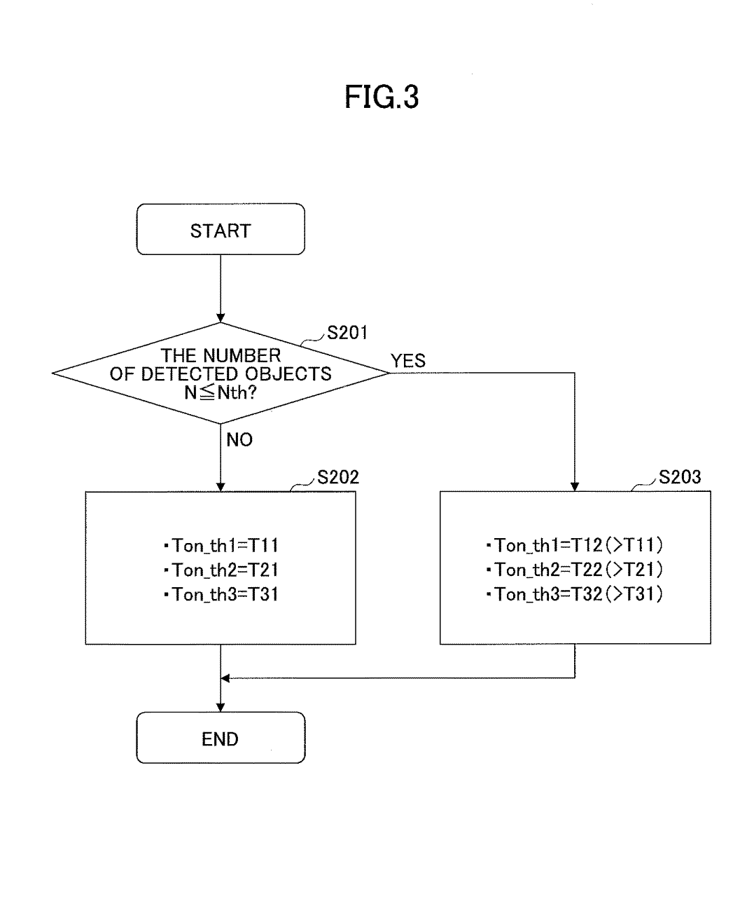

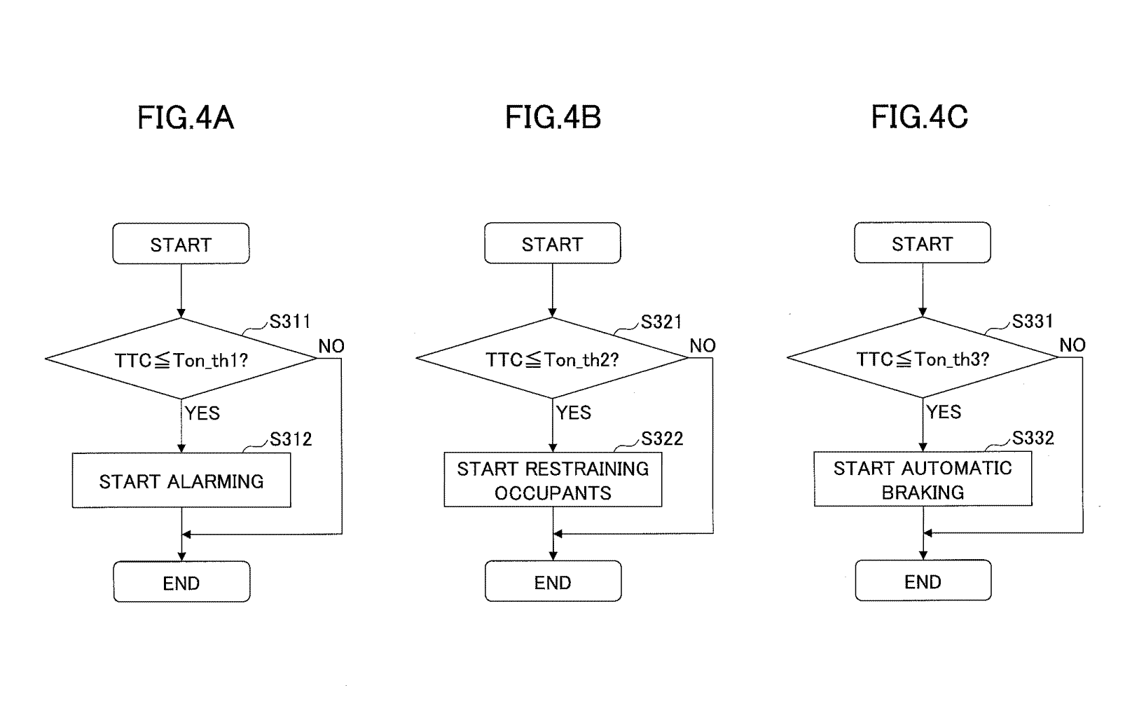

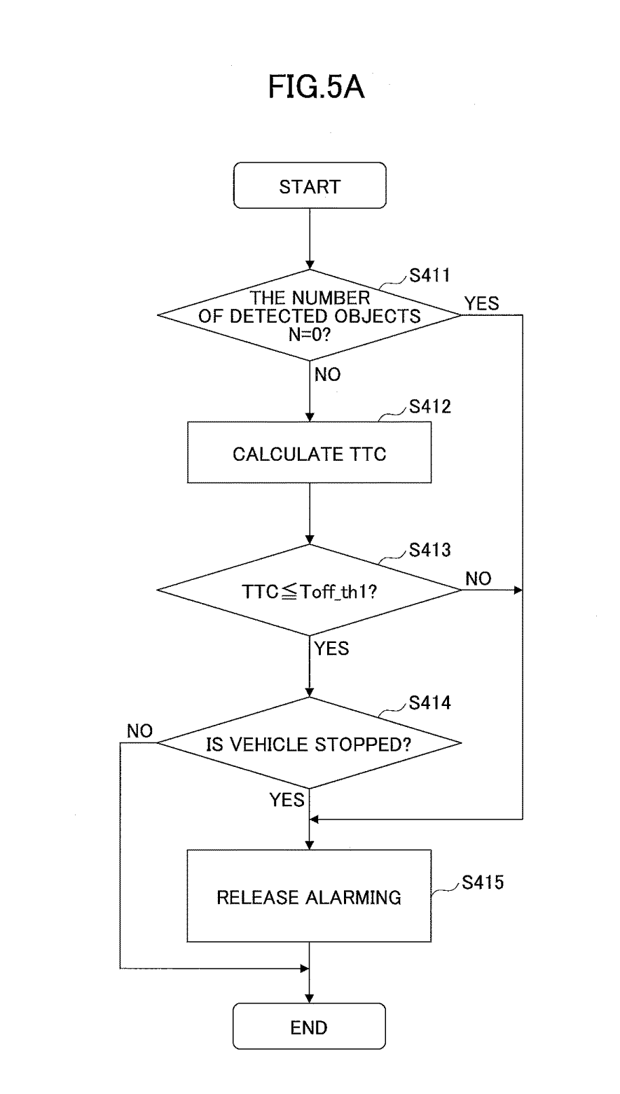

FIG. 2 to FIG. 4C are flowcharts that schematically illustrate examples of drive support start processes by the collision avoidance apparatus 1 according to the present embodiment. FIG. 2 is a main flowchart that schematically illustrates an example of the drive support start process by the collision avoidance apparatus 1 according to the present embodiment. FIG. 3 is a sub-flowchart of the drive support start process illustrated in FIG. 2 that specifically illustrates details of Step S200 in the main flowchart in FIG. 2, which will be described later. FIGS. 4A to 4C are sub-flowcharts of the drive support start process illustrated in FIG. 2 that specifically illustrate details of Step S300 in the main flowchart in FIG. 2, which will be described later.

Note that a process of the main flowchart illustrated in FIG. 2 is started when an object ahead of the vehicle 100 is detected by the object detection unit 10, and is repeatedly executed during a period while the object is being detected. Also, Step S300 described later is executed for a drive support among the drive supports of the alarming, occupant restraining, and automatic braking that has not been started. The process of the main flowchart terminates when all drive supports have been started by Step S300. Also, if a collision is detected while executing the process of the main flowchart, the PCS-ECU 50 terminates the process of the main flowchart, and continues a state to generate the braking force of the vehicle 100 automatically until the vehicle 100 is stopped.

At Step S100, the PCS-ECU 50 calculates a TTC based on object information received from the object detection unit 10.

At Step S200, depending on the number of detected objects N received from the object detection unit 10, the PCS-ECU 50 sets start timings of the drive supports of the alarming, occupant restraining, and automatic braking. To be specific, the PCS-ECU 50 sets the thresholds Ton_th1, Ton_th2, and Ton_th3 described above.

Note that Step S200 may be executed in parallel with Step S100, or may be executed in order exchanged with Step S100.

Here, details of Step S200 will be described using FIG. 3.

At Step S201, the PCS-ECU 50 determines whether the number of detected objects N received from the object detection unit 10 is less than or equal to a predetermined number Nth. If the number of detected objects N is not less than or equal to the predetermined number Nth, the PCS-ECU 50 goes forward to Step S202; or if the number of detected objects N is less than or equal to the predetermined number Nth, the PCS-ECU 50 goes forward to Step S203.

Note that the predetermined number Nth is an integer greater than or equal to one, for example, one. In the following, the description assumes that Nth is one.

At Step S202, the PCS-ECU 50 sets the thresholds Ton_th1, Ton_th2, and Ton_th3 to predetermined values T11, T21, and T31, respectively.

Note that the magnitudes of the predetermined values T11, T21, and T31 satisfy a relationship T11>T21>T31>0. Also, the predetermined values T11 and T31 are set in advance based on an experiment or a computer simulation, as values that correspond to TTCs with which it may be determined that a collision between the vehicle 100 and the detected object would be inevitable if the drive supports of the alarming and automatic braking are not executed.

On the other hand, at Step S203, the PCS-ECU 50 sets the thresholds Ton_th1, Ton_th2, and Ton_th3 to predetermined values T12 (>T11), T22 (>T21), and T32 (>T31), respectively.

Note that the magnitudes of the predetermined values T12, T22, and T32 satisfy a relationship 112>T22>T32>0. Also, the predetermined values T12 and T32 are set in advance based on an experiment or a computer simulation, as values that correspond to TTCs with which it may be determined that the likelihood is high for a collision between the vehicle 100 and the detected object if the drive supports of the alarming and automatic braking are not executed.

In other words, if the number of detected objects N is one, the PCS-ECU 50 advances the timings to start the respective drive supports with respect to a predicted timing of the collision between the vehicle 100 and the detected object, compared to a case where the number of detected objects is greater than one.

Referring to FIG. 2 again, at Step S300, the PCS-ECU 50 determines whether to start the drive supports, by using the respective thresholds Ton_th1, Ton_th2, and Ton_th3 set at Step S200.

Here, details of Step S300 will be described using FIGS. 4A to 4C.

FIGS. 4A to 4C are sub-flowcharts that schematically illustrate examples of processes to determine whether to start alarming, occupant restraining, and automatic braking, respectively.

First, using FIG. 4A, a process will be described that determines whether to start alarming.

At Step S311, the PCS-ECU 50 determines whether the TTC is less than or equal to the threshold TFon_th1. If the TTC is less than or equal to the threshold TFon_th1, the PCS-ECU 50 goes forward to Step S312; or if the TTC is not less than or equal to the threshold TFon_th1, the PCS-ECU 50 terminates the current process.

At Step S312, the PCS-ECU 50 starts the alarming to warn the driver of the vehicle 100. To be specific, the PCS-ECU 50 outputs an operation signal to the alarm buzzer 60, and outputs an alarm display signal to the meter 70.

Next, using FIG. 4B, a process will be described that determines whether to start occupant restraining.

At Step S321, the PCS-ECU 50 determines whether the TTC is less than or equal to the threshold TFon_th2. If the TTC is less than or equal to the threshold TFon_th2, the PCS-ECU 50 goes forward to Step S322; or if the TTC is not less than or equal to the threshold TFon_th2, the PCS-ECU 50 terminates the current process.

At Step S322, the PCS-ECU 50 starts the occupant restraining, namely, outputs an occupant restraining signal to the seat belt 80 (or the pretensioner).

Next, using FIG. 4C, a process will be described that determines whether to start automatic braking.

At Step S331, the PCS-ECU 50 determines whether the TTC is less than or equal to the threshold Ton_th3. If the TTC is less than or equal to the threshold Ton_th3, the PCS-ECU 50 goes forward to Step S332; or if the TTC is not less than or equal to the threshold TFon_th3, the PCS-ECU 50 terminates the current process.

At Step S332, the PCS-ECU 50 starts the automatic braking, namely, outputs a request for automatic braking to the brake ECU 90.

Next, processes to release drive supports by the collision avoidance apparatus 1 according to the present embodiment (i.e., drive support release processes) will be described in detail.

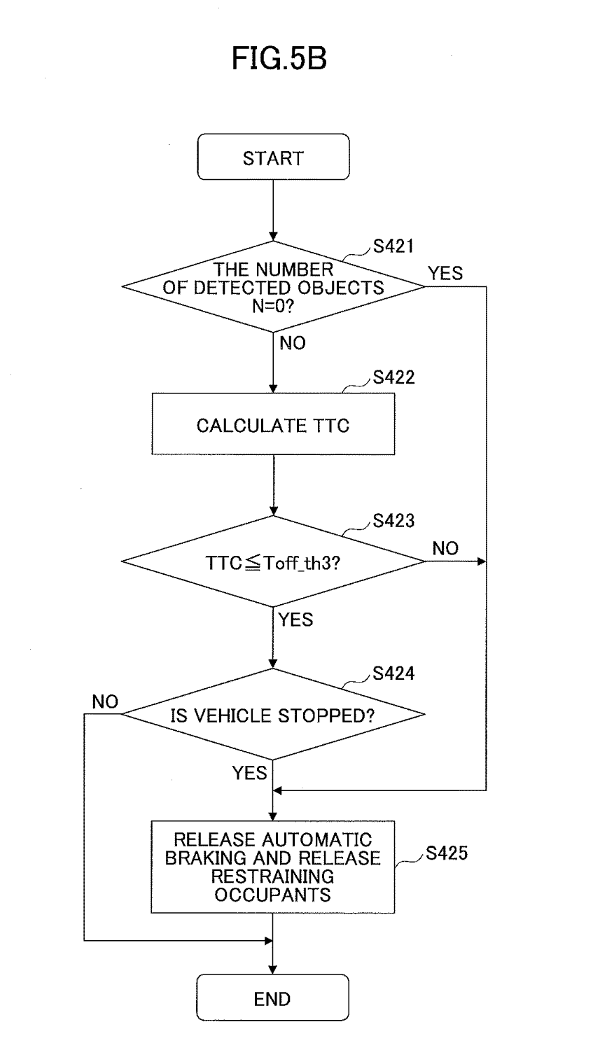

FIGS. 5A and 5B are sub-flowcharts that schematically illustrate examples of drive support release processes by the collision avoidance apparatus 1 according to the present embodiment. FIG. 5A represents an example of a process to release alarming, and FIG. 5B represents an example of a process to release automatic braking and occupant restraining.

Note that a process of the flowchart illustrated in FIG. 5A is started when alarming to warn the driver of the vehicle 100 is started by Step S312 in FIG. 4A, and is repeatedly executed every predetermined interval while the alarming continues. Also, a process of the flowchart illustrated in FIG. 5B is started when automatic braking is started by Step S332 in FIG. 4C, and is repeatedly executed every predetermined interval while the automatic braking continues. Also, if a collision is detected while executing the processes of the flowcharts illustrated in FIGS. 5A and 5B, the PCS-ECU 50 terminates the processes of the flowcharts, and continues to generate the braking force of the vehicle 100 automatically until the vehicle 100 is stopped.

First, a process to release alarming will be described using FIG. 5A.

At Step S411, the PCS-ECU 50 determines whether an object ahead of the vehicle 100 is no longer detected by the object detection unit 10, namely, whether the number of detected objects N received from the object detection unit 10 is zero. If the number of detected objects N is not zero, the PCS-ECU 50 goes forward to Step S412; or if the number of detected objects N is zero, the PCS-ECU 50 goes forward to Step S415.

At Step S412, the PCS-ECU 50 calculates a TTC based on detected object information received from the object detection unit 10.

At Step S413, the PCS-ECU 50 determines whether the TTC is less than or equal to the threshold TFoff_th1. If the TTC is less than or equal to the threshold TFoff_th1, the PCS-ECU 50 goes forward to Step S414; or if the TTC is not less than or equal to the threshold TFoff_th1, the PCS-ECU 50 goes forward to Step S415.

At Step S414, the PCS-ECU 50 determines whether the vehicle 100 is stopped, based on a vehicle speed signal received from the wheel speed sensor 20. If the vehicle 100 is stopped, the PCS-ECU 50 goes forward to Step S415; or if the vehicle 100 is not stopped, the PCS-ECU 50 terminates the current process.

At Step S415, the PCS-ECU 50 releases the alarming to warn the driver of the vehicle 100, namely, outputs an operation release signal to the alarm buzzer 60, and outputs an alarm display release signal to the meter 70.

Next, a process to release automatic braking and occupant restraining will be described using FIG. 5B.

At Step S421, the PCS-ECU 50 determines whether an object ahead of the vehicle 100 is no longer detected by the object detection unit 10, namely, whether the number of detected objects N received from the object detection unit 10 is zero. If the number of detected objects N is not zero, the PCS-ECU 50 goes forward to Step S422; or if the number of detected objects N is zero, the PCS-ECU 50 goes forward to Step S425.

At Step S422, the PCS-ECU 50 calculates a TTC based on object information received from the object detection unit 10.

At Step S423, the PCS-ECU 50 determines whether the TTC is less than or equal to the threshold Toff_th3. If the TTC is less than or equal to the threshold Toff_th3, the PCS-ECU 50 goes forward to Step S424; or if the TTC is not less than or equal to the threshold Toff_th3, the PCS-ECU 50 goes forward to Step S425.

At Step S424, the PCS-ECU 50 determines whether the vehicle 100 is stopped, based on a vehicle speed signal received from the wheel speed sensor 20. If the vehicle 100 is stopped, the PCS-ECU 50 goes forward to Step S425; or if the vehicle 100 is not stopped, the PCS-ECU 50 terminates the current process.

At Step S425, the PCS-ECU 50 releases the automatic braking and the occupant restraining, namely, outputs an occupant restraining release signal to the seat belt 80 (or the pretensioner), and outputs an automatic braking release request to the brake ECU 90.

Note that if the vehicle 100 is stopped by the automatic braking, the PCS-ECU 50 executes a process to hold the braking force to maintain the stopped state of the vehicle 100 (i.e., brake holding), irrespective of a braking operation by the driver. Specifically, if the vehicle 100 is stopped by the automatic braking, the PCS-ECU 50 transmits a request for brake holding to the brake ECU 90. In response to a control command from the brake ECU 90, the brake actuator 92 operates to keep generating the braking force to maintain the stopped state of the vehicle 100.

Next, effects of the collision avoidance apparatus 1 according to the present embodiment will be described.

As described above, if the number of objects detected by the object detection unit 10 is one, the collision avoidance apparatus 1 according to the present embodiment advances the start timings of the drive supports of the alarming and automatic braking, compared to a case where the number of detected objects is greater than one. Specifically, if the number of objects detected by the object detection unit 10 is one, the collision avoidance apparatus 1 sets the thresholds Ton_th1 and Ton_th3, which correspond to the start timings of the drive supports, to greater values, compared to a case where the number of detected objects is greater than one. Thus, the collision avoidance apparatus 1 can start executing the drive supports at comparatively early timings to avoid a collision between the vehicle 100 and an object ahead of the vehicle, while avoiding execution of unnecessary drive supports.

Specifically, if the number of objects detected by the object detection unit 10 (the number of detected objects N) is comparatively greater, detection precision tends to be worse for detected object information (the relative position and relative speed of an object), and/or detection of an object itself may be executed less precisely. For example, if using a radar, there is a likelihood that reflected waves from the objects may overlap each other. Therefore, it tends to be difficult to precisely separate a reflected wave that corresponds to one of the objects among the overlapping reflected waves, to detect the object and/or to calculate the position and the like of the detected object. Also, if using a camera, there is a likelihood that objects may overlap each other in a captured image. Therefore, it tends to be difficult to precisely identify a range that corresponds to each of the objects in the captured image, and consequently, the precision may be inferior for detection of the relative positions and the like of the objects. Therefore, if the drive supports are set to be started at comparatively earlier timings uniformly, unnecessary drive supports may be executed highly frequently, due to less precise information in a case where the number of objects detected by the object detection unit 10 is comparatively greater.

Thereupon, if the number of detected objects N is not less than or equal to the predetermined number Nth, the drive supports are started at respective timings with which it may be determined that a collision between the vehicle 100 and the detected object would be inevitable if the drive supports are not executed. Thus, the collision avoidance apparatus 1 can avoid a collision with a detected object, while avoiding execution of unnecessary drive supports.

On the other hand, if the number of objects detected by the object detection unit 10 (the number of detected objects N) is comparatively less, detection precision tends to increase for detected object information, and/or detection of an object itself. Therefore, the likelihood is low that unnecessary drive supports are executed. Thereupon, if the number of detected objects N is less than or equal to the predetermined number Nth, the drive supports are started at respective timings with which it may be determined that the likelihood is high for a collision between the vehicle 100 and the detected object if the drive supports are not executed. Thus, the drive supports can be started with a certain allowance of time, and it is possible to avoid a collision between the vehicle 100 and the detected object more securely. In this way, the collision avoidance apparatus 1 can start executing drive supports at comparatively early timings to avoid a collision between the vehicle 100 and an object ahead of the vehicle, while avoiding execution of unnecessary drive supports.

Especially, if the number of detected objects N is one, it is not affected by the other detected objects. Therefore, noise factors are reduced when detecting an object or calculating the relative position of the detected object and the like, and the precision of the detected object information can be raised very much. Therefore, by setting the predetermined number Nth to one, the collision avoidance apparatus 1 can start executing drive supports at comparatively early timings to avoid a collision between the vehicle 100 and an object ahead of the vehicle, while avoiding a situation where drive supports are executed unnecessarily due to influence of the other detected objects.

Note that as described above, the predetermined number Nth is an integer greater than or equal to one, and may be set to an integer greater than or equal to two. For example, if an allowance level is specified about precision for detecting an object or detecting the relative position and the like of the object by the object detection unit 10, and the allowance level can be achieved by the precision characteristic of a sensor adopted in the object detection unit 10 when three objects are detected, the predetermined number may be set Nth=3.

Also, the timing to start each of the drive supports may be set by multiple stages of two or more. To be specific, as described above, if the number of objects detected by the object detection unit 10 (the number of detected objects N) is comparatively less, precision tends to be high for detected object information that is output from the object detection unit 10, and detection of an object itself by the object detection unit 10. Therefore, the timing to start each of the drive supports may be set earlier stepwise while the number of detected objects N is less. For example, the thresholds Ton_th1 and Ton_th3 may be set stepwise greater while the number of detected objects N decreases from more than five, down to four, three, two, and one.

### Second Embodiment

Next, a second embodiment will be described.

The collision avoidance apparatus 1 according to the present embodiment changes only the start timing of the alarming depending on the number of detected objects N. To be specific, if the number of detected objects N is less than or equal to the predetermined number Nth, the collision avoidance apparatus 1 according to the present embodiment advances the start timing of the alarming, compared to a case where the number of detected objects is greater than the predetermined number Nth, but does not change the start timings of the automatic braking and the occupant restraining, which differs from the first embodiment. In the following, the same elements as in the first embodiment are assigned the same codes, and different parts will be mainly described.

At Step S200 in FIG. 2 described above, instead of the step described in the first embodiment, the PCS-ECU 50 sets or changes only the start timing of the alarming depending on the number of detected objects N, namely, only the threshold Ton_th1. Specifically, if the number of detected objects N is not less than or equal to the predetermined number Nth (NO at Step S201 in FIG. 3 described above), at Step S202 in FIG. 3, instead of the step described in the first embodiment, the PCS-ECU 50 sets only the threshold Ton_th1 to the predetermined value T11. Also, if the number of detected objects N is less than or equal to the predetermined number Nth (YES at Step S201 in FIG. 3 described above), at Step S203 in FIG. 3, instead of the step described in the first embodiment, the PCS-ECU 50 sets only the threshold Ton_th1 to the predetermined value T12.

On the other hand, the thresholds Ton_th2 and Ton_th3, which correspond to the start timings of the occupant restraining and the automatic braking, respectively, are set to fixed values irrespective of the number of detected objects N. To be specific, the threshold Ton_th2 and the threshold Ton_th3 are fixed to the predetermined values T21 and T31, respectively, which correspond to TTCs with which it may be determined that a collision between the vehicle 100 and the detected object would be inevitable if the automatic braking is not executed.

In this way, in the present embodiment, if the number of detected objects N is less than or equal to the predetermined number Nth, the collision avoidance apparatus 1 advances only the start timing of the alarming among the drive supports, compared to a case where the number of detected objects N is greater than the predetermined number Nth. Thus, the collision avoidance apparatus 1 can start executing the alarming at a comparatively early timing to securely avoid a collision between the vehicle 100 and an object ahead of the vehicle, while further avoiding execution of unnecessary automatic braking.

Specifically, as described above, if the number of objects detected by the object detection unit 10 (the number of detected objects N) is comparatively less, precision tends to be high for detected object information that is output from the object detection unit 10, and detection of an object by the object detection unit 10. However, for example, when using a radar sensor, even if the number of detected objects N is less than or equal to Nth, a circumstance may not be completely excluded where the cover of a manhole on a road, which has a comparatively high strength of a reflected wave, is erroneously detected as an object with which a collision is to be avoided. To be specific, there is a likelihood that the drive supports are executed unnecessarily by a factor other than the number of detected objects N.

Note that since the alarming is a drive support to indicate that there is a likelihood of a collision to the driver by sound or display, executing the alarming unnecessarily may give a sense of troublesomeness to the driver, but does not affect a following vehicle. On the other hand, since the automatic braking is a drive support to generate a braking force for the vehicle 100 automatically, executing the automatic braking may give a sense of troublesomeness to the driver of the vehicle 100, and the driver of a following vehicle may be forced to make an unexpected steering operation (for lane change) or a brake operation. Therefore, it is further desirable to avoid unnecessary execution of the automatic braking more than the alarming.

Thereupon, in the present embodiment, if the number of detected objects N is less than or equal to the predetermined number Nth, the collision avoidance apparatus 1 advances only the start timing of the alarming among the drive supports, compared to a case where the number of detected objects N is greater than the predetermined number Nth. On the other hand, among the drive supports, the start timings of the automatic braking and the occupant restraining associated with the automatic braking are fixed to timings with which it may be determined that a collision between the vehicle 100 and the detected object would be inevitable if the automatic braking is not executed, irrespective of the number of detected objects N.

Note that as in the first embodiment, the timing to start each of the drive supports may be set earlier stepwise while the number of detected objects N is less.

### Third Embodiment

Next, a third embodiment will be described.

The collision avoidance apparatus 1 according to the present embodiment advances the start timings of the drive supports, depending on whether a detected object stands still, in addition to the number of detected objects N, which differs from the first embodiment. In the following, the same elements as in the first embodiment are assigned the same codes, and different parts will be mainly described.

At Step S200 in FIG. 2 described above, instead of the step described in the first embodiment, the PCS-ECU 50 sets or changes the thresholds Ton_th1 to Ton_th3 depending on the number of detected objects N, and whether a detected object stands still. Specifically, at Step S201 in FIG. 3 described above, instead of the step described in the first embodiment, the PCS-ECU 50 determines whether the number of detected objects N is less than or equal to the predetermined number Nth, and whether a detected object stands still. If the number of detected objects N is not less than or equal to the predetermined number Nth, or a detected object does not stand still, the PCS-ECU 50 sets the thresholds Ton_th1, Ton_th2, and Ton_th3 to the predetermined values T11, T21, and T31 (Step S202 in FIG. 3). Also, if the number of detected objects N is less than or equal to the predetermined number Nth, and a detected object stands still, the PCS-ECU 50 sets the thresholds Ton_th1, Ton_th2, and Ton_th3 to the predetermined values T12, T22, and T32 (Step S203 in FIG. 3).

Note that the PCS-ECU 50 can determine whether a detected object stands still or moves, based on the relative speed of the detected object included in the detected object information.

In this way, in the present embodiment, if the number of detected objects N is less than or equal to the predetermined number Nth, and a detected object stands still, the collision avoidance apparatus 1 according to the present embodiment advances the start timings of the drive supports, compared to a case where the conditions are not satisfied. Thus, the collision avoidance apparatus 1 can start executing a drive support at a comparatively early timing to avoid a collision between the vehicle 100 and an object ahead of the vehicle, while avoiding execution of unnecessary drive supports.

Specifically, for example, if a detected object is a preceding vehicle that is traveling, the preceding vehicle may accelerate, decelerate, or move to the left or right (lane change). Therefore, the relative relationship (relative position and relative speed) with respect to the vehicle 100 changes every moment. This means that there is a likelihood that a collision can be avoided by acceleration and lane change of the preceding vehicle after the drive supports have been started. Therefore, if the drive supports are set to be started at comparatively earlier timings uniformly, chances may be increased to avoid a collision by acceleration and lane change of the preceding vehicle after the drive supports have been started, namely, the drive supports that turn out to be unnecessary may be executed highly frequently.

Thereupon, in the present embodiment, as a condition to advance the start timings of the drive supports, a detected object that stands still is taken into account, in addition to the number of detected objects N less than or equal to the predetermined number Nth. Thus, the above inconvenience can be avoided.

Note that as in the first embodiment, the timing to start each of the drive supports may be set earlier stepwise while the number of detected objects N is less.

Also, as in the second embodiment, if the number of detected objects N is less than or equal to the predetermined number Nth, and a detected object as a target to avoid a collision stands still, the collision avoidance apparatus 1 may advance only the start timing of the alarming among the drive supports, compared to a case where the conditions are not satisfied.

The embodiments have been described in detail. Note that the preferred embodiments are not limited to the above, but various changes, substitutions, and alterations could be made.

For example, in the embodiments described above, distinctive technological contents have been disclosed assuming that an object positioned ahead of the vehicle is detected to execute drive supports of the alarming, automatic braking and the like for avoiding a collision between the detected object and the vehicle, but the contents are not limited to that. To be specific, the technological contents disclosed in the embodiments described above are applicable to a case where an object positioned around the vehicle, irrespective of a direction as viewed from the vehicle, is detected to execute the drive supports for avoiding a collision between the detected object and the vehicle. For example, the technological contents disclosed in the embodiments described above may be applied to a drive support (e.g., a flashing hazard lamp (FHL)) for avoiding a collision with a following vehicle that approaches the rear of the vehicle. To be specific, depending on the number of detected objects, the start timing of the FHL may be advanced. Also, in a case where the vehicle travels backward, the technological contents disclosed in the embodiments described above may be applied to drive supports (e.g., alarming, automatic braking and the like) for avoiding a collision with a detected object positioned in the traveling direction (backward) of the vehicle. To be specific, if the vehicle travels backward, depending on the number of detected objects behind the vehicle, the start timings of the drive supports may be brought forward to avoid a collision with a detected object behind the vehicle.

Note that the FHL is a drive support that blinks the hazard lamp disposed at a rear part of the vehicle when a likelihood reaches a certain high level (e.g., the TTC is less than or equal to a predetermined threshold) for the vehicle to collide with a following vehicle approaching from behind. This makes it possible to prompt the driver of the following vehicle to take a driving operation (e.g., a braking operation or a steering operation) to avoid a collision between the vehicle 100 and the following vehicle.

Also, in the embodiments described above, the TTC is used as an indicator to determine whether the likelihood is high or low for the vehicle to collide with a detected object around it, but it is not limited to such a configuration. To be specific, based on the distance to a detected object and the relative speed and the like of the detected object, a likelihood of a collision between the vehicle and the detected object may be determined to start drive supports including alarming, automatic braking, FHL etc., for avoiding a collision if the likelihood of the collision becomes greater than or equal to a predetermined level. For example, the distance to a detected object may be used as an indicator to determine whether the likelihood of a collision is high or low, to start drive supports including alarming, automatic braking, FHL etc., for avoiding a collision if the distance to the detected object becomes less than or equal to a predetermined threshold. Also, deceleration required to avoid a collision that is calculated based on the distance to a detected object and the relative speed of the detected object, may be used as an indicator to determine whether the likelihood of a collision is high or low, to start drive supports to avoid a collision if the required deceleration becomes greater than or equal to a predetermined threshold.

1. A collision avoidance apparatus for a vehicle, the apparatus comprising:
an object sensor configured to detect one or more objects around the vehicle, including an object with which a collision is to be avoided; and
an electronic control unit configured to
(i) determine a likelihood of collision of the vehicle with the object, based on at least one of a distance between the vehicle and the object, and a relative speed of the object with respect to the vehicle; and
(ii) start executing a drive support to avoid the collision between the vehicle and the object when the likelihood of the collision is greater than or equal to a first level,
wherein a value of the first level is reduced in a case where a number of the objects detected by the object sensor is less than or equal to a predetermined number than in a case where the number of the objects is greater than the predetermined number.

2. The collision avoidance apparatus as claimed in claim 1, wherein the predetermined number is one.

3. The collision avoidance apparatus as claimed in claim 1, wherein
the drive support includes issuing an alarm to warn a driver of the vehicle that the likelihood exists for the vehicle to collide with the object positioned in a traveling direction of the vehicle, and automatic braking to generate a braking force of the vehicle automatically,
the electronic control unit causes the alarm to be issued when the likelihood of the collision becomes greater than or equal to the first level, and starts the automatic braking when the likelihood of the collision becomes greater than or equal to a second level that is greater than or equal to the first level, and
a value of the second level is reduced in the case where the number of objects detected by the object sensor is less than or equal to the predetermined number than in the case where the number of the objects is greater than the predetermined number.

4. The collision avoidance apparatus as claimed in claim 1, wherein
the drive support includes issuing an alarm to warn a driver of the vehicle that the likelihood exists for the vehicle to collide with the object positioned in a traveling direction of the vehicle, and
the electronic control unit starts generating a braking force of the vehicle automatically when the likelihood of the collision becomes greater than or equal to a fixed second level which is greater than the first level.

5. The collision avoidance apparatus as claimed in claim 1, wherein the value of the first level is reduced in the case where the number of objects detected by the object sensor is less than or equal to the predetermined number, and one of the objects is stationary, than in a case where the number of the objects is greater than the predetermined number, or all of the objects are moving.
